(19) United States
(12) Patent Application Publication
(10) Pub. No.: US 2007/0285837 A1
(43) Pub. Date: Dec. 13, 2007

(54) Perpendicular magnetic recording head for high recording density

(75) Inventors: Young-hun Im, Yongin-si (KR); Yong-su Kim, Yongin-si (KR); Kook-hyun Sunwoo, Yongin-si (KR); Hyun-jei Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/730,435

(22) Filed: Apr. 2, 2007

(30) Foreign Application Priority Data
Jun. 8, 2006 (KR) 10-2006-0051237

(51) Int. Cl. G11B 5/147

(52) U.S. Cl. 360/126

(57) ABSTRACT

Provided is a perpendicular magnetic recording head for high density recording. The perpendicular magnetic recording head includes a coil, a return pole, a sub-yoke, and a main pole. The main pole has a pole tip including a second end surface that is spaced a predetermined distance from the return pole and faces the perpendicular magnetic recording medium, and surrounding at least a portion of the first end surface.

### CROSS-REFERENCE TO RELATED PATENT APPLICATION

This application claims the benefit of Korean Patent Application No. 10-2006-0051237, filed on Jun. 8, 2006, in the Korean Intellectual Property Office, the disclosure of which is incorporated herein in its entirety by reference.

### BACKGROUND OF THE INVENTION

1. Field of the Invention

The present invention relates to a perpendicular magnetic recording head, and more particularly, to a perpendicular magnetic recording head for achieving a stable high recording density by providing a magnetic field sufficient for high recording density even when a main pole of the recording head has a small tip.

2. Description of the Related Art

Magnetic recording methods can be classified into longitudinal magnetic recording methods and perpendicular magnetic recording methods depending on the data recording method. In the longitudinal magnetic recording methods, data is recorded using a characteristic that a magnetization direction of a magnetic layer is aligned parallel to a surface of the magnetic layer. On the other hand, in the perpendicular magnetic recording methods, data is recorded using a characteristic that a magnetization direction of a magnetic layer is aligned in a direction perpendicular to a surface of the magnetic layer. Therefore, the perpendicular magnetic recording methods are more advantageous than the longitudinal magnetic recording methods in terms of data recording density.

FIG. 1 is a view illustrating a conventional perpendicular magnetic recording head. Referring to FIG. 1, the conventional perpendicular magnetic recording head includes a recording head unit 100 which records data on a recording medium 10 and a read head unit 110 which reads data from the recording medium 10.

The recording head 100 includes a main pole P1, a return pole 105, and a coil C. The coil C generates a magnetic field for recording data on the recording medium 10. The recording medium 10 may include a recording layer 13, an intermediate layer 12 and an underlayer layer 11. The coil C generates a magnetic field and the main pole P1 and the return pole 105 form a magnetic path of the magnetic field. The main pole P1 and the return pole 105 each may be formed of a magnetic material such as NiFe. At this point, it is possible to form various saturation flux density Bs of the main pole P1 and the return pole 105 by adjusting the composition of the materials of the main pole P1 and the return pole 105. A sub-yoke 101 is formed on a lateral side of the main pole P1 to constitute a magnetic path of a recording magnetic field together with the main pole P1 and the return pole 105.

The read head 110 includes a first magnetic shield layer S1, a second magnetic shield layer S2, and a unit sensor 111 formed between the first and second magnetic shield layers S1 and S2. While data stored in a predetermined region A_{RP} on a selected track is read, the first and second magnetic shield layers S1 and S2 prevent the magnetic field generated from a magnetic element outside the region A_{RP} from reaching the read sensor 111.

An air bearing surface (ABS) is defined as a plane where the recording head 100 faces a recording layer 13 of the recording medium 10. In FIG. 1, the ABS is parallel to an X-Y plane.

A perpendicular component of a magnetic field that is generated from the main pole P1 and directed to the recording medium 10 magnetizes a magnetic domain of the recording medium 10 in order to record data. A unit magnetized in this manner is called a recording bit. As the recording density increases, the size of a recording bit decreases.

The recording density is generally represented by areal density, that is, by the number of recording bits per square inch. Both a length in a down-track direction and a length in a cross-track direction should decrease in order to increase an areal density. The length in the down-track direction is determined by the speed of movement of the recording medium 10, the frequency of a recording current, and the length of the main pole P1 in an X-direction. The length in the cross-track direction depends on the length of the main pole P1 in a Y-axis direction and a shape of the main pole P1. That is, as the recording density increases, the size of the tip of a pole decreases. The tip of a pole is an end of the main pole P1, which faces the recording medium. On the other hand, as the size of the tip of the pole decreases, a magnetic field for recording decreases, so that a recording performance deteriorates, making it difficult to constantly increase the recording density. Therefore, a problem due to the reduction in a magnetic field should be solved in order to increase the recording density and achieve a stable recording characteristic.

### SUMMARY OF THE INVENTION

According to an aspect of the present invention, there is provided a perpendicular magnetic recording head for recording or reading data to and from a perpendicular magnetic recording medium, the perpendicular magnetic recording head including: a coil which serves as a source generating a magnetic field for recording; a return pole which constitutes a magnetic path of the magnetic field; a sub-yoke which constitutes the magnetic path of the magnetic field together with the return pole, the sub-yoke including a first surface facing the return pole, a second surface facing away from the return pole, and a first end surface facing the perpendicular magnetic recording medium, wherein the first end surface is located away from an air bearing surface (ABS) area and from the perpendicular magnetic recording medium; and a main pole which extends along the first surface or the second surface of the sub-yoke and further extends from the first end surface of the sub-yoke toward the ABS, wherein the main pole comprises a pole tip which has a second end surface facing with a distance the magnetic recording medium and being spaced from the return pole, the pole tip surrounding at least a portion of the first end surface.

According to another aspect of the invention, the pole tip has at least one surface which is at least partially tapered to have a narrower end toward the ABS, and a magnetic field from the main pole is concentrated on the second end surface.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a conventional perpendicular magnetic recording head;

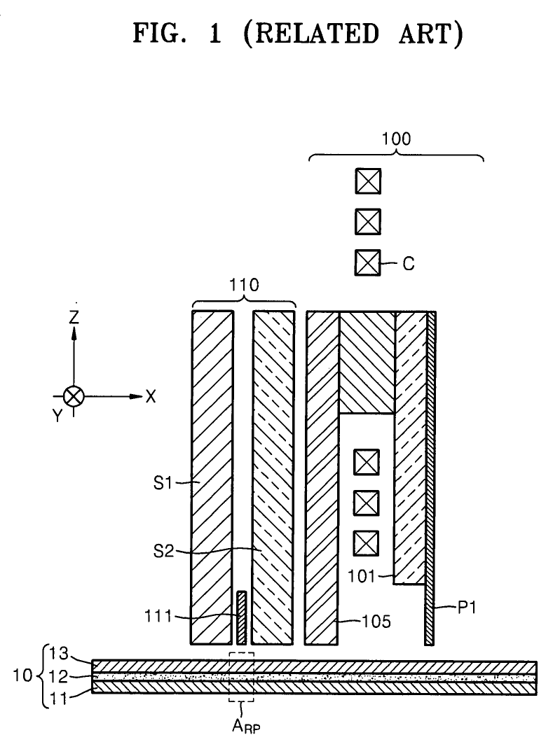

FIG. 2 is a view of a perpendicular magnetic recording head according to a first exemplary embodiment of the present invention;

FIG. 3 is a view of a perpendicular magnetic recording head of a comparison example;

FIG. 4 shows magnetic field characteristics in a down-track direction of the magnetic recording system of the comparison example and the first exemplary embodiment of the present invention;

FIG. 5 is a view of a perpendicular magnetic recording head according to a second exemplary embodiment of the present invention;

FIG. 6 shows magnetic field characteristics in a down-track direction of the magnetic recording system of the comparison example and the second exemplary embodiment of the present invention;

FIG. 7 is a view of a perpendicular magnetic recording head according to a third exemplary embodiment of the present invention;

FIG. 8 shows magnetic field characteristics in a down-track direction of the magnetic recording system of the comparison example and the third exemplary embodiment of the present invention;

FIG. 9 is a view of a perpendicular magnetic recording head according to a fourth exemplary embodiment of the present invention;

FIG. 10 is a view of a perpendicular magnetic recording head according to a fifth exemplary embodiment of the present invention;

FIG. 11 shows magnetic field characteristics in a down-track direction of the magnetic recording system of the comparison example and the fifth exemplary embodiment of the present invention; and

FIG. 12 is a view of a perpendicular magnetic recording head according to a sixth exemplary embodiment of the present invention.

### DETAILED DESCRIPTION OF THE INVENTION

The present invention will now be described more fully with reference to the accompanying drawings, in which exemplary embodiments of the invention are shown. Like reference numerals in the drawings denote like elements. In the drawings, sizes of elements are exaggerated for clarity and convenience in description.

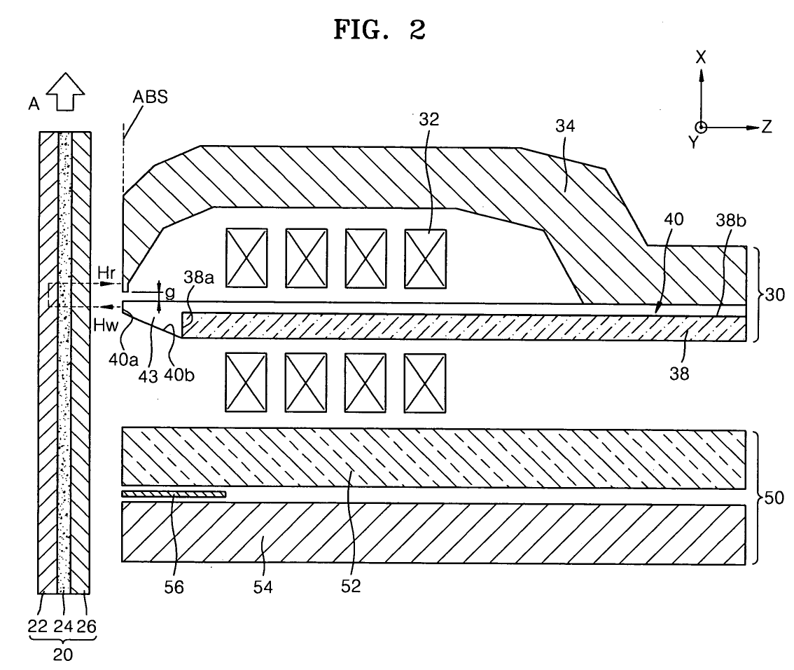

FIG. 2 is a view of a perpendicular magnetic recording head according to a first exemplary embodiment of the present invention. Referring to FIG. 2, the perpendicular magnetic recording head includes a recording head unit 30 which records data on a perpendicular magnetic recording medium 20 (referred to as a recording medium 20) and a read head unit 50 which reads data from the recording medium 20.

The recording head unit 30 includes a coil 32 which serves as a source generating a magnetic field for recording; a return pole 34 which forms a magnetic path of the magnetic field generated by the coil 32; a sub-yoke 38 which forms a magnetic path of the magnetic field together with the return pole 34; and a main pole 40 which forms a magnetic path in cooperation with the return pole 34 and the sub-yoke 38 and applies the magnetic field to the recording medium 20. An air bearing surface (ABS) is defined as a plane where the recording head 30 faces the recording layer 13. In FIG. 2, the ABS is parallel to an X-Y plane.

The return pole 34 and the sub-yoke 38 are arranged around the coil 32 to form a magnetic path of a magnetic field generated from the coil 32. The sub-yoke 38 has a first end surface 38a that faces a recording layer 26 of the recording medium 20 and a first surface 38b which is perpendicular to the recording layer 26 of the recording medium. The recording medium 20 may include a recording layer 26, an intermediate layer 24 and a soft magnetic underlayer 22. The first end surface 38a is located away from the ABS. It is also located at a distance from the recording medium 20.

The main pole 40 extends along the first surface 38b of the sub-yoke 38 and further extends from the first end surface 38a of the sub-yoke 38 toward the recording medium 20. The main pole 40 has a second end surface 40a, which faces the recording layer 26 of the recording medium 20 and located in the ABS area. Also, the main pole 40 has a pole tip 43 which has a tapered end. The pole tip 43 concentrates a magnetic field to its tapered narrow end, i.e., the second end surface 40a. The pole tip 43 may have a shape which surrounds at least a portion of the first end surface 38a such that a magnetic field is condensed on the second end surface 40a. That is, the pole tip 43 has a shape such that a thickness of the pole tip 43 in a direction perpendicular to a first surface 38b of the sub-yoke 38 decreases toward the ABS. For example, the pole tip 43 has an inclined surface 40b that is inclined with respect to the first surface 38b. Also, the pole tip 43 may be in contact the entire first end surface 38a to surround the first end surface 38a such that a magnetic flux that has passed through the sub-yoke 38 is linked to the pole tip 43 without leakage to the outside. In this case, a magnetic flux that has passed through the return pole 34 and the sub-yoke 38 can be more efficiently concentrated on the second end surface 40a of the main pole.

Each of the main pole 40, the return pole 34, and the sub-yoke 38 may generally be formed of a magnetic material such as NiFe to form a magnetic path of a recording magnetic field generated from the coil 32. At this point, saturation flux density Bs of the main pole 40, the return pole 34, and the sub-yoke 38 may be controlled to have different values by adjusting the compositions of the magnetic materials of the main pole 40, the return pole 34, and/or the sub-yoke 38. Since the amount of a magnetic flux that can be condensed on the second end surface 40a of the main pole 40 is limited by the saturation flux density Bs of materials that constitute the main pole 40, return pole or sub-yoke 38, the main pole 40 may be formed of a material having greater saturation flux density Bs than that of the sub-yoke 38.

A gap g of a predetermined distance is formed between the pole tip 43 and the return pole 34 in the ABS area, so that leakage magnetic flux is generated from the second end surface 40a of the main pole 40. The recording medium 20 is a perpendicular magnetic recording medium, and has a structure of a soft magnetic underlayer 22, an intermediate layer 24, and a recording layer 26. A perpendicular component of a recording magnetic field that leaks from the second end surface 40a vertically magnetizes the recording layer 26, so that recording is performed. The recording magnetic field can be divided into a recording field Hw directed from the second end surface 40a to the recording medium 20, and a return field Hr that passes through the recording medium 20 and enters the return pole 34. A recording characteristic can be analyzed using the recording field Hw and the return field Hr. The distance (i.e., gap g) between the return pole 34 and the pole tip 43 in the ABS area, is not limited particularly as long as a magnetic field leaking from the second end surface 40a passes through the soft magnetic underlayer 22 of the recording medium 20 and constitutes a return path. In general, the gap g may be about 500 nm or less.

The read head unit 50 reading data from the recording medium 20 is further provided on a lateral side of the recording head 30. The read head unit 50 includes a first shield layer 52, a second shield layer 54, and a read sensor 56 located between the first and second shield layers 52 and 54. One end of each of the first shield layer 52, the second shield layer 54, and the read sensor 56 is formed in the ABS area. The read sensor 56 may be a magnetoresistance device such as a giant magnetoresistance (GMR) device or a tunnel magnetoresistance (TMR) device.

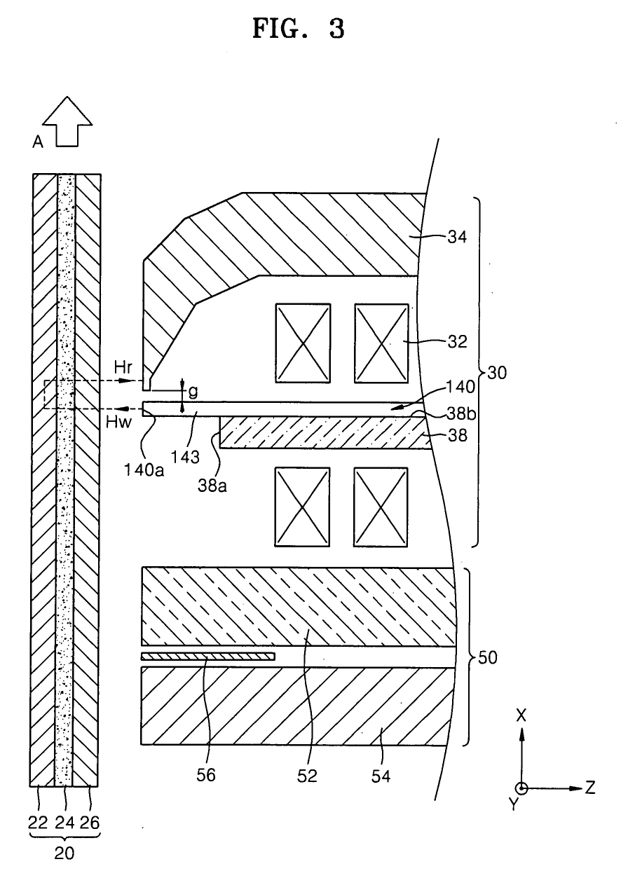

FIG. 3 is a view of a perpendicular magnetic recording head of a comparison example. Referring to FIG. 3, the perpendicular magnetic recording head of the comparison example has the same construction as that of the perpendicular magnetic recording head illustrated in FIG. 2, except the structure of a main pole 140. That is, the main pole 140 has a second end surface 140a that faces a perpendicular magnetic recording medium 20 (referred to as a recording medium 20) and is located between a sub-yoke 38 and a return pole 34. A pole tip 143 of the main pole 140 is not in contact with a first end surface 38a of the sub-yoke 38 and has a shape where the thickness of a cross-section of the pole tip 143 that is parallel to an ABS is constant.

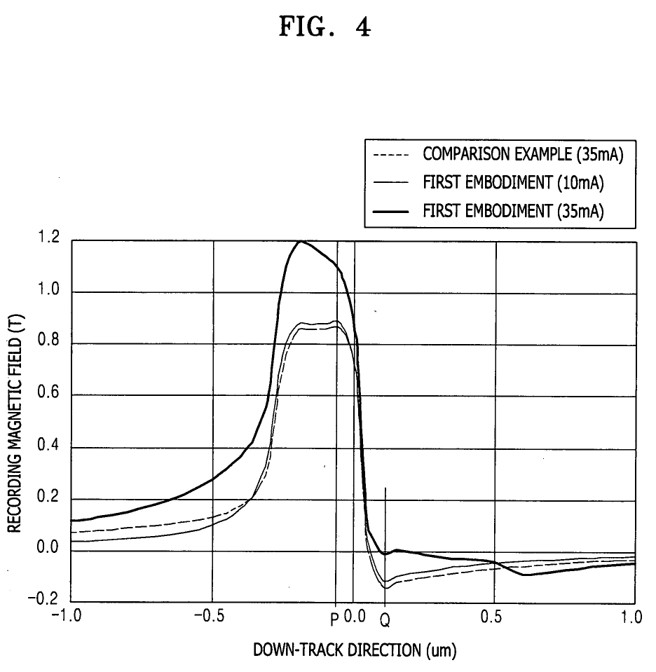

FIG. 4 shows magnetic field characteristics in a down-track direction of the magnetic recording system of the comparison example and the first embodiment of the present invention. The term “down-track direction” indicates a direction in which a recording medium 20 progresses. It is denoted by an arrow “A” in FIG. 2, and corresponds to an X-direction. A magnetic field generated from the perpendicular magnetic recording head can be divided into a recording field Hw that is generated from the second end surface 140a of the main pole 140 and a return field Hr that passes through the recording medium 20 and returns to the return pole 34 as described above. In FIG. 4, the symbols “P” and “Q” each represent the points where the recording field Hw and the return field Hr are generated, respectively. Since the recording field Hw and the return field Hr have directions opposite to each other, the recording field Hw and the return field Hr are represented by having a positive sign and a negative sign, respectively. Assuming the magnetic recording head of the first exemplary embodiment of the present invention produces a recording shape and a field pattern that are similar even when a current decreases to 10 mA, the inventive magnetic recording head generates a higher recording field Hw and a smaller return field Hr than those of the comparison example, for the currents of 10 mA and 35 mA.

Table 1 compares in detail a recording characteristic of a comparison example with that of the first embodiment of the present invention by analyzing the graph illustrated in FIG. 4.

TABLE 1

| | | | Return | Field | Field |
|---|---|---|---|---|---|
| | | Recording | field, | ratio, | gradient |
| # | Model (current) | field, H_{w} (T) | Hᵣ (T) | H_{w}/Hᵣ | (0e/nm) |
| #0 | Comparison | 0.862 | 0.132 | 6.54 | 141.8 |
| | Example | | | | |
| | (35 mA) | | | | |
| #1-1 | First embodiment | 0.882 | 0.106 | 8.29 | 134.11 |
| | (10 mA) | | | | |
| #1-2 | First embodiment | 1.19 | 0.086 | 13.87 | 148.8 |
| | (35 mA) | | | | |

| | | | | |
|---|---|---|---|---|
| #1-1 improvement rate | 2% (↑) | 20% (↓) | 27% (↑) | 5.4% (↓) |
| #1-2 improvement rate | 38% (↑) | 35% (↓) | 110% (↑) | 5% (↑) |

Since the return field Hr is formed in a direction opposite to a direction of the recording field Hw, a high recording field Hw and a low return field provide an advantageous condition for recording. A magnetic field characteristic was compared using a quantity defined as Hw/Hr. A field gradient is a factor having an influence on a signal-to-noise ratio (SNR). A higher field gradient indicates good SNR characteristics.

Referring to Table 1, the magnetic recording head according to the first exemplary embodiment of the present invention, even for a case where the current is 10 mA, which was lower than the current (35 mA) of the comparison example, had a higher recording field Hw and a lower return field Hr than those of the comparison example, resulting an improvement of a field ratio by 27%. A field gradient of the inventive head was slightly lower than that of the comparison example. When a current was 35 mA, the recording field Hw of the inventive head increased by 38% and the return field Hr of the inventive head decreased by 35%, compared to those of the comparative example, which indicates an improvement of the field ratio and field gradient by 110% 5%, respectively.

A variety of exemplary embodiments of a perpendicular magnetic recording head according to the present invention will be described below. Since these embodiments are the same as the first exemplary embodiment of the present invention except for the main pole, only different parts will be described.

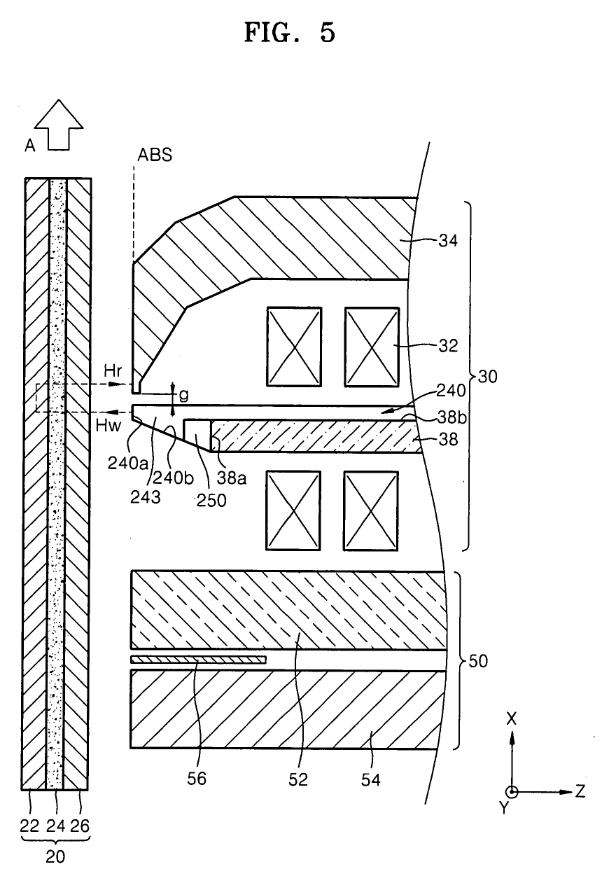

FIG. 5 is a view of a perpendicular magnetic recording head according to a second exemplary embodiment of the present invention. Referring to FIG. 5, a main pole 240 has a second end surface 240a that faces a recording medium 20 and located in an ABS area. The main pole 240 extends along the first surface 38b of the sub-yoke 38 and further extends from the first end surface 38a of the sub-yoke 38 toward the recording medium 20. Also, the main pole 240 has a pole tip 243 which has a tapered end. The pole tip 243 condenses a magnetic field to its tapered narrow end, i.e., the second end surface 240a. The pole tip 243 may have a shape which surrounds a portion of the first end surface 38a such that a magnetic field is condensed on the second end surface 240a. That is, the pole tip 243 has a shape such that a thickness of the pole tip 243 in a direction perpendicular to a first surface 38b of the sub-yoke 38 reduces toward the ABS. For example, the pole tip 243 has an inclined surface 240b inclined with respect to the first surface 38b. The pole tip 243 is not in direct contact with the first end surface 38a. A material region 250 formed of a material different from that of the pole tip 243 is further provided between the pole tip 243 and the first end surface 38a. The material region 250 can be formed of one of a magnetic material having a saturation flux density Bs which is different from the saturation flux density Bs of the pole tip 243, and can be formed of an insulating material such as Al₂O₃.

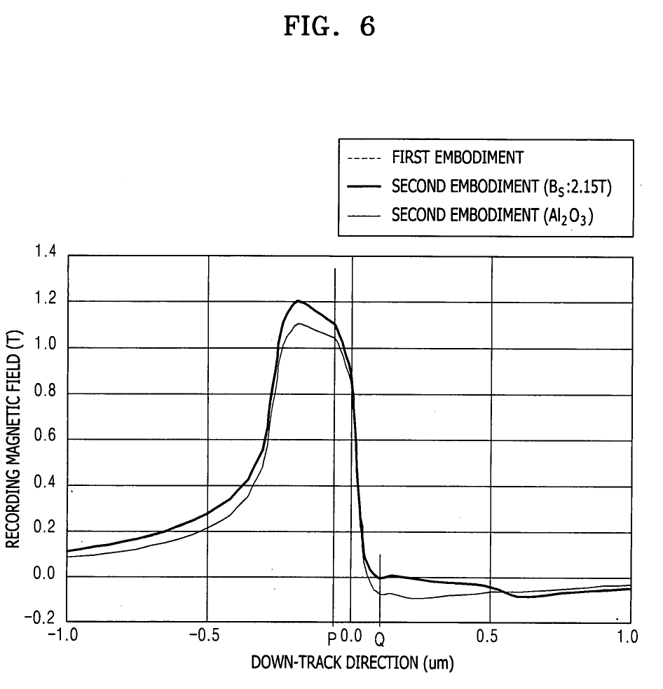

FIG. 6 shows magnetic field characteristics of a first and second exemplary embodiments of the present invention. The first embodiment substantially corresponds to a case where the material region 250 is formed of the same material as that of the pole tip 243. On the other hand, in the second embodiment, the material region 250 is formed of either of a magnetic material having a saturation flux density Bs of 1.5 T or an insulating material of Al₂O₃. It is assumed that the saturation flux density Bs of the pole tip 243 is 2.15 T. In FIG. 6, the symbols “P” and “Q” each represent the points where a recording field Hw and a return field Hr are generated, respectively. Referring to the graph illustrated in FIG. 6, the second embodiment where the material region 250 is formed of a magnetic material having a saturation flux density Bs of 1.5 T shows almost the same characteristic as that of the first embodiment (that is, the first embodiment curve (- - - - ) is not noticeable in FIG. 6). On the other hand, the second embodiment where the material region 250 is formed of an insulating material of Al₂O₃ shows more or less different recording magnetic field distributions as compared to that of the first embodiment.

Table 2 compares in detail a recording characteristic of the second embodiment with that of the first embodiment of the present invention by analyzing the graph illustrated in FIG. 6.

TABLE 2

| | | Recording | Return | Field | Field |
|---|---|---|---|---|---|
| | | field, | field, | ratio, | gradient |
| # | Model (material) | H_{w} (T) | Hᵣ (T) | H_{w}/Hᵣ | (0e/nm) |
| #1-2 | First embodiment | 1.19 | 0.086 | 13.78 | 148.8 |
| | (Bs: 2.15T) | | | | |
| #2-1 | Second embodiment | 1.19 | 0.087 | 13.74 | 148.7 |
| | (Bs: 1.5T) | | | | |
| #2-2 | Second embodiment | 1.09 | 0.094 | 11.6 | 150.3 |
| | (Al₂O₃) | | | | |

| | | | | |
|---|---|---|---|---|
| Comparison of #2-1 with | — | — | 0.3% (↓) | — |
| #1-2 | | | | |
| Comparison of #2-2 with | 8% (↓) | 9% (↑) | 16% (↓) | 1% (↑) |
| #1-2 | | | | |

Referring to Table 2, when the material region 250 is formed of a magnetic material, a recording magnetic field characteristic shows a minor difference depending on the saturation flux density Bs. That is, when the material region 250 is formed of a magnetic material, the recording magnetic field characteristic has been improved compared to the comparison example discussed above. When the material region 250 is formed of Al₂O₃, a field gradient was very close to that of the first embodiment, and a field ratio decreased by 16% as compared to that of the first embodiment. However, even in the latter case, the recording magnetic field characteristics has improved compared to the comparison example #0 in Table 1.

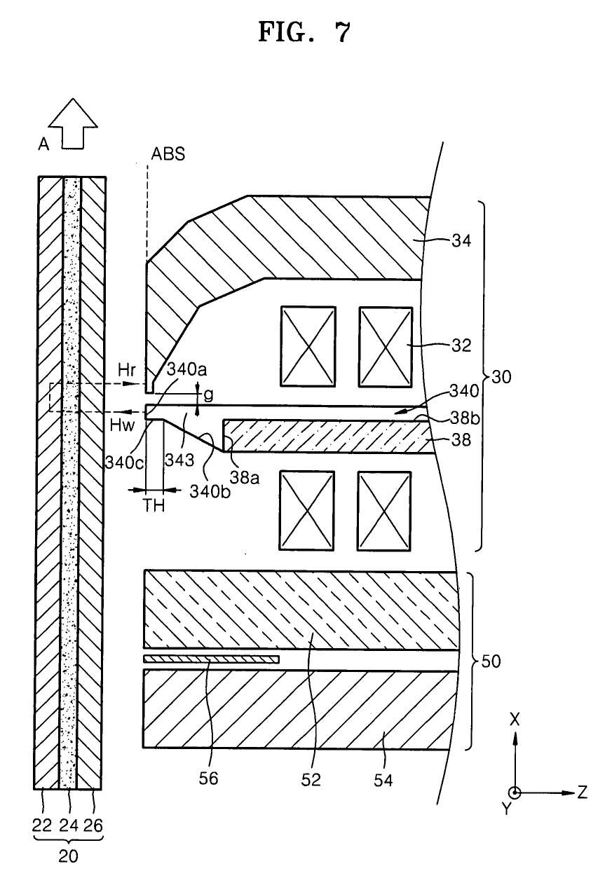

FIG. 7 is a view of a perpendicular magnetic recording head according to a third exemplary embodiment of the present invention. Referring to FIG. 7, a main pole 340 has a second end surface 340a that faces a recording medium 20 and located in an ABS area. Also, the main pole 340 has a pole tip 343 of a shape that allows a magnetic field to be condensed on its tapered narrow end, i.e., the second end surface 340a. The pole tip 343 has a shape where a thickness of a cross-section of the pole tip 343 that is parallel to the ABS (i.e., perpendicular to the first surface 38b of the sub-yoke 38) decreases as it is toward the ABS such that a magnetic field is condensed on the second end surface 340a. For example, the pole tip 343 an inclined surface 340b inclined with respect to the first surface 38b. The pole tip 343 may have a shape in which the pole tip 343 is in contact with the entire surface of a first end surface 38a of the sub-yoke 38 such that a magnetic field is effectively condensed on the second end surface 340a. The pole tip 343 may be partially tapered. The tapered part or the inclined surface 340b is in contact with the first end surface 38a and the non-tapered narrower part 340c is close to the ABS area. In the exemplary embodiment as shown in FIG. 7, the non-tapered narrow end of the pole tip 343 has a throat height (TH) from the ABA area.

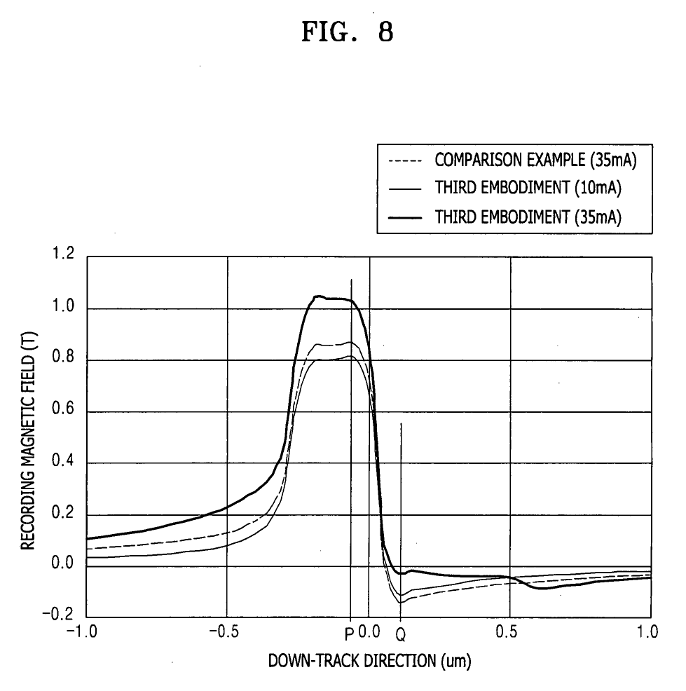

FIG. 8 shows magnetic field characteristics in a down-track direction of the magnetic recording system of the comparison example and the third exemplary embodiment of the present invention.

In FIG. 8, the symbols “P” and “Q” each represent the points where the recording field Hw and the return field Hr are generated, respectively. Assuming the magnetic recording head of the third exemplary embodiment of the present invention produces a recording type or a field pattern that are similar even when a current decreases to 10 mA, the inventive magnetic recording head generates a lower recording field Hw and return field Hr than those of the comparison example, at a current of 10 mA. The third exemplary embodiment produces a higher recording field Hw and a lower return field Hr than the comparison example, at a current of 35 mA.

Table 3 compares in detail a recording characteristic of the third embodiment with that of the comparison example by analyzing the graph illustrated in FIG. 8.

TABLE 3

| | | | Return | Field | Field |
|---|---|---|---|---|---|
| | | Recording | field, | ratio, | gradient |
| # | Model (current) | field, H_{w} (T) | Hᵣ (T) | H_{w}/Hᵣ | (0e/nm) |
| #0 | Comparison | 0.862 | 0.132 | 6.54 | 141.8 |
| | Example | | | | |
| | (35 mA) | | | | |
| #3-1 | Third embodiment | 0.811 | 0.104 | 7.88 | 134.11 |
| | (10 mA) | | | | |
| #3-2 | Third embodiment | 1.04 | 0.083 | 12.56 | 148.8 |
| | (35 mA) | | | | |

| | | | | |
|---|---|---|---|---|
| #3-1 improvement rate | 6% (↓) | 21% (↓) | 20% (↑) | 12% (↓) |
| #3-2 improvement rate | 21% (↑) | 37% (↓) | 92% (↑) | 3% (↑) |

Referring to Table 3, the third embodiment, where the current was 10 mA, showed 20% improved field ratio while its recording field Hw and return field Hr each were lower than those of the comparison example. Also, the third embodiment, where the current was 35 mA, had a higher recording field Hw and a lower return field Hr than those of the comparison example, indicating improvements of a field ratio and a field gradient by 92% and 3%, respectively.

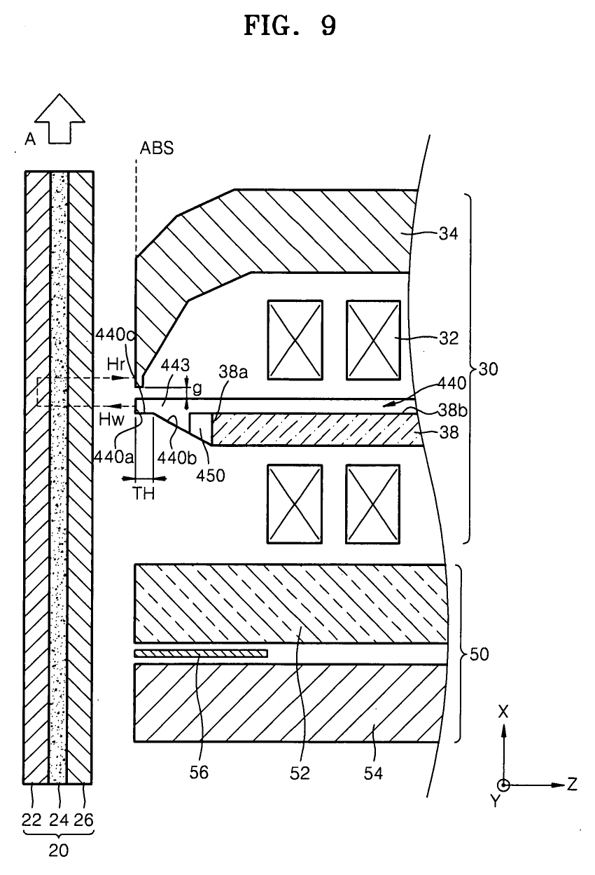

FIG. 9 is a view of a perpendicular magnetic recording head according to a fourth exemplary embodiment of the present invention. Referring to FIG. 9, a main pole 440 has a second end surface 440a that faces a recording medium 20 and located in an ABS area. Also, the main pole 440 has a pole tip 443 of a shape that allows a magnetic field to be condensed on the second end surface 440a. The pole tip 443 has a shape where the thickness of a cross-section of the pole tip 443 that is parallel to the ABS decreases towards the ABS such that a magnetic field is condensed on the second end surface 440a. That is, the pole tip 443 has a shape such that the thickness of the pole tip 443 in a direction perpendicular to a first surface 38b of the sub-yoke 38 reduces as it is toward the ABS. For example, the pole tip 443 has a tapered surface or an inclined surface 440b inclined with respect to the first surface 38b. The pole tip 443 is partially tapered. The tapered part or the inclined surface 440b is positioned farther away from the ABS area than the non-tapered narrower part 440c. In the exemplary embodiment as shown in FIG. 9, the non-tapered narrow part 440c of the pole tip 443 has a throat height (TH) from the ABA area. A material region 450, which is formed of a material different from that of the pole tip 443, is further provided between the pole tip 443 and a first end surface 38a. The material region 450 can be formed of one of a magnetic material having saturation flux density Bs different from the saturation flux density Bs of the pole tip 443, or an insulting material such as Al₂O₃.

The fourth embodiment illustrated in FIG. 9, is a modification of the third embodiment illustrated in FIG. 7 As expected, the fourth embodiment has similar characteristics to those of the third embodiment as shown in Table 2 where the second embodiment is compared with the first embodiment.

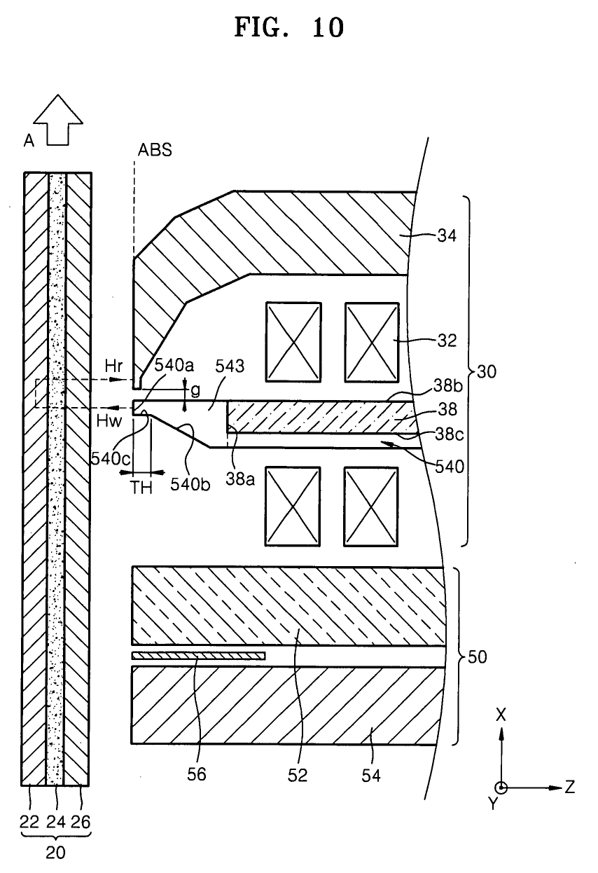

FIG. 10 is a view of a perpendicular magnetic recording head according to a fifth exemplary embodiment of the present invention. Referring to FIG. 10, a main pole 540 has a second end surface 540a that faces a recording medium 20 and located in an ABS area. The sub-yoke 38 has at least three faces, one of which is a first surface 38a which faces a return pole 34. The second face of the sub-yoke 38 is a second surface (or bottom surface) 38c which faces away from the return pole 34 and the third face of the sub-yoke 38 is a first end surface 38a which faces the recording medium 20. The main pole 540 extends along a second surface (bottom surface) 38c of the sub-yoke 38 and further extends from a first end surface 38a. Also, the main pole 540 has a pole tip 543 of a shape that allows a magnetic field to be condensed on the second end surface 540a. The pole tip 543 surrounds at least a portion of the first end surface 38a such that a magnetic field is condensed on the second end surface 540a. The pole tip 543 also is tapered to have a narrower end as it towards the ABS. That is, the pole tip 543 has a shape such that the thickness of the pole tip 543 in a direction perpendicular to a first surface 38b of the sub-yoke 38 reduces at it is toward the ABS. For example, the pole tip 543 has a tapered surface or an inclined surface 540b which is inclined with respect to the first surface 38b. The pole tip 543 may be in contact with an entire surface of the first end surface 38a to completely surround the first end surface 38a in order to more effectively condense a magnetic field on the second end surface 540a. The pole tip 543 may be partially tapered. The tapered part or the inclined surface 540b is in contact with the first end surface 38a and the non-tapered narrower part 540c is close to the ABS area. In the exemplary embodiment as shown in FIG. 7, the non-tapered narrow end 540c of the pole tip 543 has a throat height (TH) from the ABA area.

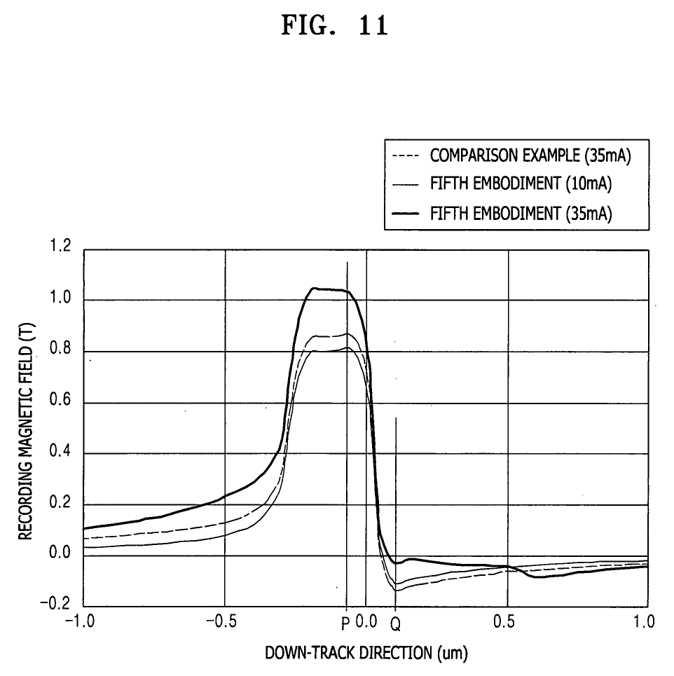

FIG. 11 shows magnetic field characteristics in a down-track direction of the magnetic recording system of the comparison example and the fifth exemplary embodiment of the present invention. In FIG. 11, the symbols “P” and “Q” each represent the points where the recording field Hw and the return field Hr are generated, respectively. Assuming the magnetic recording head of the fifth exemplary embodiment of the present invention produces a recording type or a field pattern that are similar even when a current decreases to 10 mA, the inventive magnetic recording head generates a lower recording field Hw and return field Hr than those of the comparison example, at a current of 10 mA. The fifth exemplary embodiment produces a higher recording field Hw and a lower return field Hr than the comparison example, at a current of 35 mA. Table 4 compares in detail a recording characteristic of the fifth embodiment with that of the comparison example by analyzing the graph illustrated in FIG. 11.

TABLE 4

| | | | Return | Field | Field |
|---|---|---|---|---|---|
| | | Recording | field, | ratio, | gradient |
| # | Model (current) | field, Hw (T) | Hr (T) | Hw/Hr | (0e/nm) |
| #0 | Comparison | 0.862 | 0.132 | 6.54 | 141.8 |
| | (35 mA) | | | | |
| #5-1 | Fifth embodiment | 0.81 | 0.103 | 7.89 | 123.84 |
| | (10 mA) | | | | |
| #5-2 | Fifth embodiment | 1.04 | 0.083 | 12.62 | 146.7 |
| | (35 mA) | | | | |

| | | | | |
|---|---|---|---|---|
| #5-1 improvement rate | 6% (↓) | 22% (↓) | 21% (↑) | 12.7% (↓) |
| #5-2 improvement rate | 21% (↑) | 37% (↓) | 93% (↑) | 3% (↑) |

Referring to Table 4, the fifth embodiment, where the current was 10 mA, has improved 21% of field ratio while having a lower recording field Hw and return field Hr than the comparison example. Also, the fifth embodiment, where the current was 35 mA, had a higher recording field Hw and a lower return field Hr than the comparison example, indicating improvements in a field ratio and a field gradient by 93% and 3%, respectively.

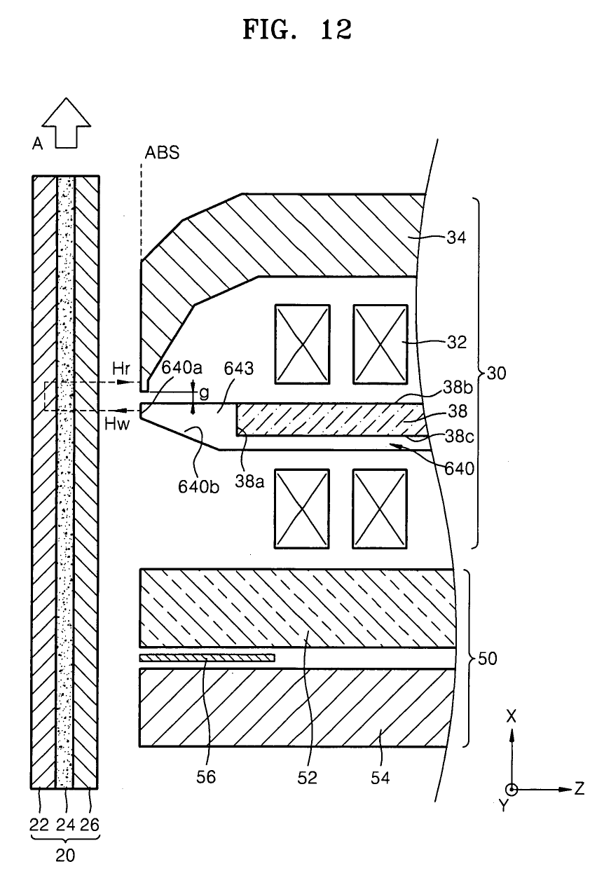

FIG. 12 is a view of a perpendicular magnetic recording head according to a sixth exemplary embodiment of the present invention. The sixth embodiment of the present invention is the same as the fifth embodiment except that an inclined surface 640b of a main pole 640 starts from an ABS, that is, a throat height (TH) is zero. In other words, the sixth embodiment is a modification where the TH is not exist as opposite to the fifth embodiment in which the pole tip 643 of the main pole 640 is partially tapered. Therefore, as expected from the results of the experiments employing the first and third embodiments, the sixth embodiment had the same or improved characteristics as compared to the fifth embodiment.

Perpendicular magnetic recording heads according to the fifth and sixth embodiments have a structure that is different from the first through fourth embodiments in that the main pole 540 or 640 of the fifth and sixth embodiments, respectively, is formed on the second surface (bottom surface) 38c of the sub-yoke 38. Since a detailed shape and material of the pole tip 543 (643) can be modified in various ways as described above in the previous embodiments and can be deduced from those embodiments, detailed descriptions and illustrations thereof will be omitted.

The present invention having the above-described construction provides a perpendicular magnetic recording head having an excellent recording magnetic field characteristic capable of providing improved high recording density by varying the design of a pole tip of a main pole.

As described above, a pole tip surrounding at least a portion of a sub-yoke is formed such that a magnetic field can be more effectively condensed on a second end surface that faces a perpendicular magnetic recording medium, so that a recording field becomes high, a return field becomes low, and a field ratio and a field gradient improve.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording head for recording or reading data to and from a perpendicular magnetic recording medium, the perpendicular magnetic recording head comprising:
a coil which serves as a source generating a magnetic field for recording;
a return pole which constitutes a magnetic path of the magnetic field;
a sub-yoke which constitutes the magnetic path of the magnetic field together with the return pole, the sub-yoke comprising a first surface facing the return pole, a second surface facing away from the return pole, and a first end surface facing the perpendicular magnetic recording medium, wherein the first end surface is located away from an air bearing surface (ABS) area and from the perpendicular magnetic recording medium; and
a main pole which extends along the first surface or the second surface of the sub-yoke and further extends from the first end surface of the sub-yoke toward the ABS, wherein the main pole comprises a pole tip which has a second end surface facing with a distance the magnetic recording medium and being spaced from the return pole, the pole tip surrounding at least a portion of the first end surface.

2. The perpendicular magnetic recording head of claim 1, wherein the pole tip has at least one surface which is at least partially tapered to have a narrower end toward the ABS, and a magnetic field from the main pole is concentrated on the second end surface.

3. The perpendicular magnetic recording head of claim 2, wherein the pole tip includes an inclined surface which is inclined with respect to the first surface of the sub-yoke.

4. The perpendicular magnetic recording head of claim 2, wherein the pole tip is in contact with the first end surface of the sub-yoke.

5. The perpendicular magnetic recording head of claim 2, further comprising a material region located between the pole tip and the first end surface of the sub-yoke, the material region being formed of a material different from that of the pole tip.

6. The perpendicular magnetic recording head of claim 5, wherein the material region is formed of a magnetic material having a saturation flux density different from that of the pole tip or an insulating material.

7. The perpendicular magnetic recording head of claim 2, wherein the pole tip is tapered along the whole length of the inclined surface.

8. The perpendicular magnetic recording head of claim 2, wherein the pole tip is partially tapered and comprises a region where a cross-section of the pole tip that is parallel to the ABS is constant.

9. The perpendicular magnetic recording head of claim 7, wherein the pole tip is in contact with the first end surface of the sub-yoke.

10. The perpendicular magnetic recording head of claim 7, further comprising a material region located between the pole tip and the first end surface of the sub-yoke, the material region being a magnetic material having a saturation flux density different from that of the pole tip or an insulating material.

11. The perpendicular magnetic recording head of claim 8, wherein the pole tip is in contact with the first end surface of the sub-yoke.

12. The perpendicular magnetic recording head of claim 8, further comprising a material region located between the pole tip and the first end surface of the sub-yoke, the material region being a magnetic material having a saturation flux density different from that of the pole tip or an insulating material.

13. The perpendicular magnetic recording head of claim 1, wherein the distance on the ABS between the pole tip and the return pole is 500 nm or less.

14. The perpendicular magnetic recording head of claim 1, wherein the main pole is formed of a material having a higher saturation flux density than that of the sub-yoke.
